(19) United States
(12) Patent Application Publication
(10) Pub. No.: US 2003/0047695 A1
(43) Pub. Date: Mar. 13, 2003

(54) System and method for synchronizing a laser beam to a moving web

(75) Inventors: John J. Zik, Hudson, WI (US); Steven J. Roffers, Hammond, WI (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Preco Laser Systems, LLC, Somerset, WI

(21) Appl. No.: 10/233,754

(22) Filed: Sep. 3, 2002

Related U.S. Application Data
(60) Provisional application No. 60/317,891, filed on Sep. 7, 2001.

(51) Int. Cl. G01N 21/86; G01V 8/00

(52) U.S. Cl. 250/559.32

(57) ABSTRACT

A system for synchronizing a cutting laser beam with the motion of a moving web material includes a beam source, optics, one or two moveable mirrors, one or two mirror motors, an encoder and a computer. The encoder, which is attached to a tension roller in the system, measures the speed of the moving web and generates a signal representative of the measured speed. The encoder transmits the measured clock signal to a computer, which synchronizes the motion of the mirrors and modulates the power of the laser according to the encoder clock signal. Thus, the galvo-laser is synchronized to the moving web.

### CROSS-REFERENCE TO RELATED APPLICATION(S)

This application claims priority from Provisional Application No. 60/317,891 filed on Sep. 7, 2001, entitled “System and Method for Synchronizing a Laser Beam to a Moving Web”.

### FIELD OF THE INVENTION

The present invention relates to the control of the location of a laser beam focus point relative to a moving web. More specifically, the present invention involves a system and method for using an encoder in a galvo-based laser system for synchronizing the motion of the laser beam for both discontinuous and continuous contours with the motion of a moving web for a plurality of laser processes including cutting, perforating, scoring, slitting, marking, welding, sealing, and the like.

### BACKGROUND OF THE INVENTION

The use of lasers for scoring, forming lines of weakness or grooving thin film plastics and other materials, including fabric and the like, has been known for some time. Generally, the laser beam is focused to cause local vaporization or degradation of the material as the material or the laser is moved relative to one another.

The common and general approach for laser processing such materials on a moving web is to use two mutually perpendicular (orthogonal) mirrors to direct the laser beam. The two-mirror system performs the laser processing by moving both of the mirrors to redirect the laser beam in a predetermined pattern. In the prior art, the motion of the two mirrors/axes in a two orthogonal mirror/axis system is coordinated; however, only the axis that is in-line with the web is synchronized to the moving web. In other words, the position of the moving web is added to the position of the in-line axis. Thus, the laser process time for a pattern is always the same regardless of the web speed, even if the web stops.

### BRIEF DESCRIPTION OF THE INVENTION

A system for synchronizing a laser beam with the motion of a moving web or a conveyor for steered beam laser processing includes a beam source, optics, one or two moveable mirrors, one or two mirror motors, an encoder and a computer running controller software. The encoder, which is attached to a tension roller in the system, measures the speed of the moving web. The encoder generates an electronic signal representative of the speed of the moving web and transmits the signal to the computer. The computer uses the received signal to synchronize the motion of the moveable mirrors to the moving web and to modulate the power of the laser according to the encoder signal.

### BRIEF DESCRIPTION OF THE DRAWINGS

FIG. 1 is a schematic block diagram of the present invention.

FIG. 2 is a top view of two scan heads, each comprised of dual moving mirrors of the present invention..

FIG. 3A is a top view of a sinusoidal score pattern performed with a dual moving-mirror system in the prior art.

FIG. 3B is a top view of a score pattern that is larger than the galvo field size performed with a dual moving-mirror system in the prior art.

FIG. 4A is a top view of a sinusoidal score pattern performed with a single mirror in the present invention.

FIG. 4B is a top view of a score pattern that is larger than the galvo field size with the present invention.

FIG. 5 is a side view of the apparatus of the present invention.

While the above-identified figures set forth a preferred embodiment of a dual moving mirror system, other embodiments (such as a single moving mirror system) of the present invention are also contemplated, some of which are noted in the discussion. In all cases, this disclosure presents the illustrated embodiments of the present invention by way of representation and not limitation. Numerous other minor modifications and embodiments may be devised by those skilled in the art which fall within the scope and spirit of the principles of this invention.

### DETAILED DESCRIPTION

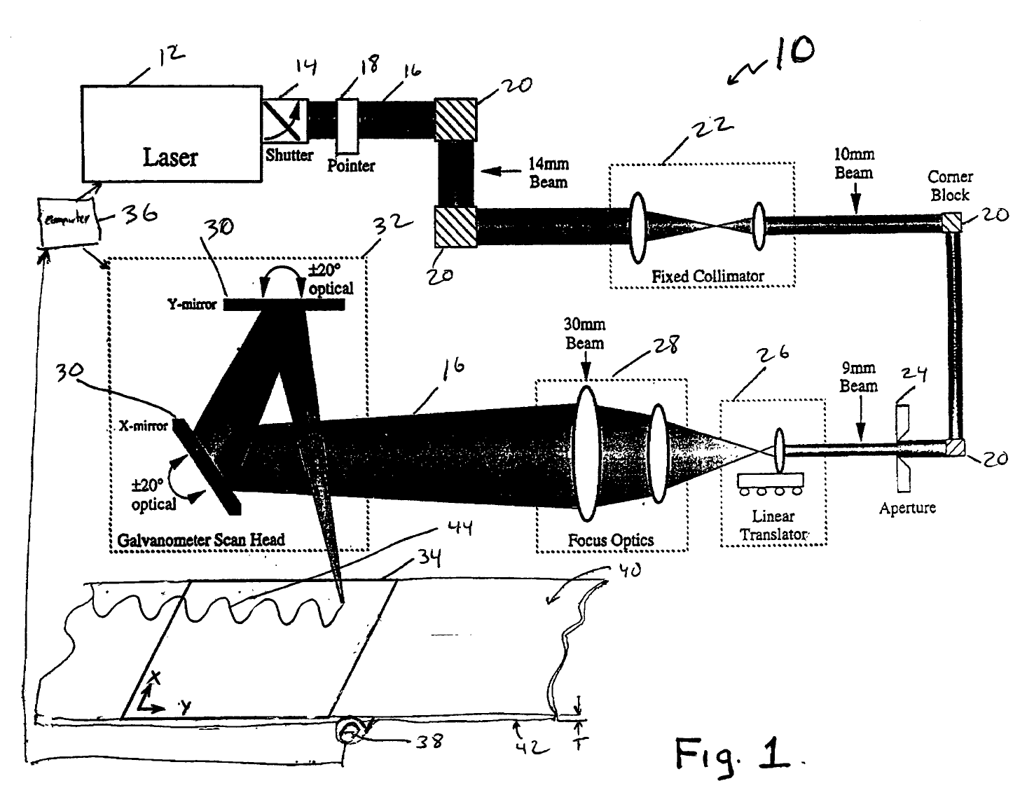

As shown in FIG. 1, the dual moving mirror system 10 includes an energy source 12 with a shutter 14 for providing a beam 16 of energy, a pointer 18, corner blocks 20, a fixed collimator 22, an aperture 24, a linear translator 26, optics 28 for focusing the beam 16, and two mirrors 30 within a galvanometer scan head 32 for directing the focused beam 16 onto a moving web 34.

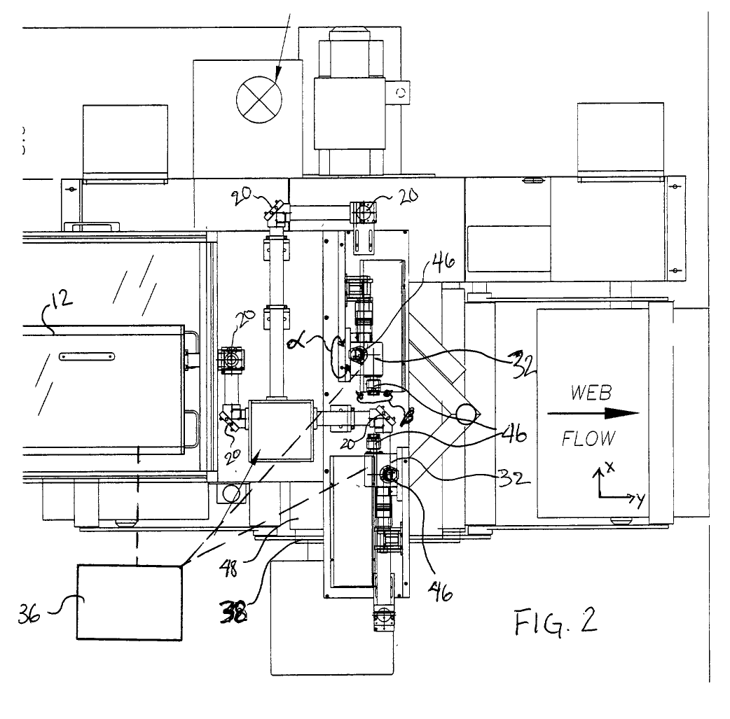

Two motors (shown in FIG. 2) within the galvanometer scan head 32 adjust the angles of the mirrors 30 relative to the moving web 34. A computer 36 controls the power of the energy source 12 as well as the motors within the scan head 32 for controlling the motion of the mirrors 30. The motors are synchonized to the moving web using an encoder 38 attached to an tension roller under the moving web 34. Generally, the system 10 performs the laser process by changing the relative angles of the mirrors 30 as the web material 34 passes under the laser beam 16.

The web material 34 has a top surface 40, a bottom surface 42, and a thickness (T) defined as the distance between the top surface 40 and the bottom surface 42. The web material 34 is supported on a table and across rollers (both driven and tension rollers). The active rollers spin to advance the web material 34, and the tension rollers direct the web material 34 under the galvo field. Additionally, tension rollers are used to exert a force on the web material 34 to maintain a constant tension so that the web material 34 does not flap during the laser process.

As shown, the laser beam 16 is directed by the moving mirror 30 to score various types of patterns 44 on the web material 34. The web material 34 advances in the y-direction, while the moving mirrors 30 vary their angles (α and β) in both the x-direction and the y-direction to produce the desired score pattern.

Using nearly 100%-reflective mirrors, the focused laser beam 16 is directed to a focal point below the top surface 40 of the moving web 34. The location of the focal point relative to the top surface 40 and bottom surface 42 of the web material 34 may be changed in consideration of energy distribution requirements, characteristics of the material, the end use of the material, or other factors relating to the speed, thickness or kerf of the desired cut. For many materials, the perpendicular distance between the foci and the top surface 40 of the material 34 is between ⅙ and ¼ the thickness T of the material, and the perpendicular distance between the foci and the bottom surface 42 is between ⅔ and ½ the thickness T of the material. The focused beam 16 vaporizes the web material 34 to conduct the laser process.

While the present invention is described with respect to one or two moving mirrors per scan head, the invention can be performed with any number of scan heads with one or two moving mirrors. The number of moving mirrors effects the number of motors, which may impact spacing between the mount arms. Depending on the application, more than one scan head may be required. The present invention contemplates synchronization of one or more scan heads, each consisting of one or more moving mirrors, to the speed of the moving web or moving conveyor.

As shown in FIG. 2, two motors 46 within each scan head 32 change the angles (α and β) of the mirrors 30 according to a control signal received from a computer 36. The motors 46 are synchronized to the moving web 34 by an encoder 38, which is attached to one of the tension rollers 48. The encoder 38 measures the motion of the tension roller 48, which provides an accurate, continuous measurement of the speed of the moving web 34. The encoder 38 transmits the measurement electrically as a clock signal to the computer 36, which uses the encoder clock signal to modulate the laser power and to synchronize the motion of mirrors 30 with the speed of the moving web 34.

The present invention utilizes the methodology of synchronizing the mirrors 30 to the web material 34, a technique called “electronic camming.” Instead of adding the position of the web 34 to the in-line mirror motion and instead of using a real-time clock (as in the prior art), the present invention utilizes an encoder 38 to generate a virtual clock signal that is tied to the speed of the moving web and that is used by the motion generator of the computer 36 to control the moving mirrors 30. In other words, the web speed is used as the time-base input for the motion generator of the computer 36. The motion generator generates the pattern to be processed using the time-base input. In this case, both mirrors 30 in a dual moving mirror system are synchronized to the web, or in a single moving mirror system, the single moving mirror 30 is synchronized to the web. By synchronizing the moving mirror 30 to the web speed, the laser processing time becomes a function of the web speed, so that as the web speed increases, the laser processing time decreases. When the web 34 is stopped, no laser processing takes place.

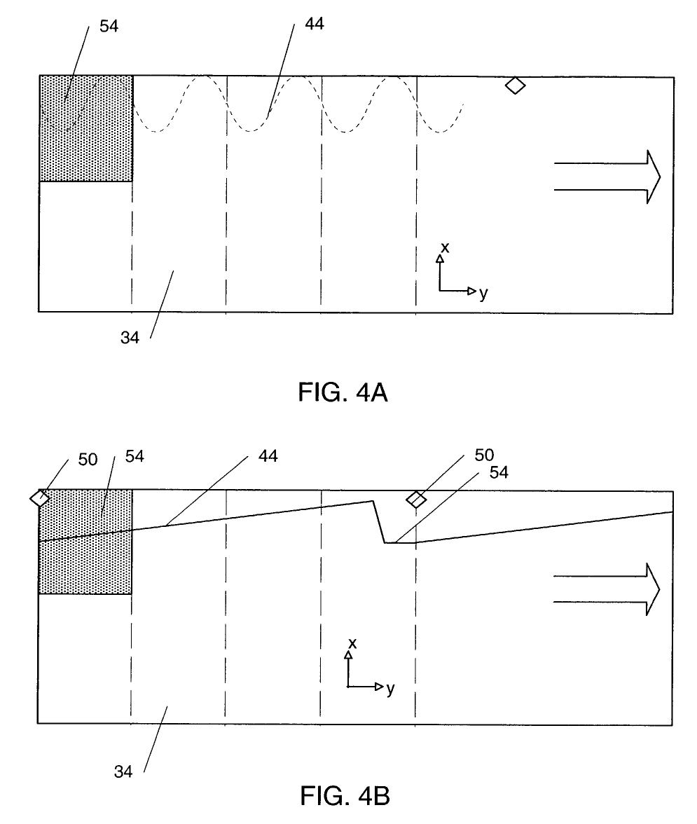

This methodology has a number of pattern-independent advantages. In some cases, the system can process the same pattern using a single-axis/mirror instead of a dual moving mirror system. In other cases, where a dual moving mirror system is required to meet the pattern requirements, it still eliminates the need to retrace or retract with the beam off. Additionally, the system eliminates the need to separate a processed pattern into smaller components if the pattern repeat is larger than the field size of the galvo (as shown in FIG. 4B). These cases are exemplified below.

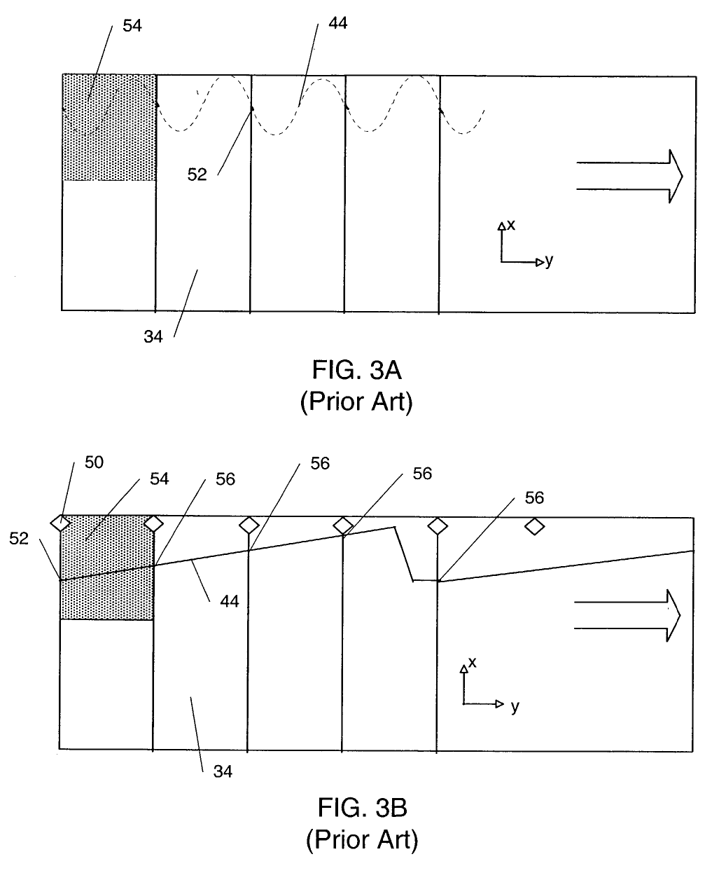

In the prior art, as shown in FIG. 3A, a continuous, repeating, sinusoidal score line 44 was difficult to produce. In the prior art, the common and general approach for laser processing a repeating, contiguous pattern 44 for an entire roll of web material 34, would be to utilize a dual moving mirror system. In the dual moving mirror system (using the in-line mirror position synchronization technique), once the pattern 44 is complete, the mirrors 30 must be retracted to the start position, typically with the laser beam 16 turned off. Using a sine wave scoring line 44 as an example, the sine wave pattern 44 is continuous, and it repeats according to a frequency. After a single cycle of the sine wave pattern 44 is completed, the mirrors 30 must retract to the starting point to begin the next sine wave pattern 44. However during the retraction phase, the laser beam 16 must be either turned off and turned back on when the retraction is complete and the web material 34 has traveled the previous pattern length so as to begin the next pattern, or the beam 16 must be kept on during the retraction.

If the beam 16 is turned off during retraction, it is difficult to maintain a consistent score depth at the start point of the next sine wave 44. Typically, at turn on, the laser beam 16 produces a high energy pulse or spike, causing inconsistent scoring at the beginning of each sine wave cycle, which can produce a deeper score mark 52. Additionally, it is difficult to restart the beam 16 at exactly the correct location to match where it was shut off.

The alternative approach requires keeping the beam 16 on during the retraction, which requires a precise retrace of the laser processed pattern 44 on the moving web 34. If the laser beam 16 is left on and the beam 16 does not accurately retrace the original score line 44, a second score line will be carved in the web material 34 by the retrace process. Additionally, during retrace, the power level of the laser beam 16 must be modified because the area of the web over which the laser beam 16 is retracting has already been scored. Neither of these approaches are necessary with the electronic camming technique as will be discussed with respect to FIGS. 4A and 4B.

Generally, each galvo mirror 30 has a laser field area 54 determined by the score pattern. Generally, the field area 54 of the galvo mirror 30 is in the shape of a square. The size of the square is determined by the length and width of the score pattern. As shown, the field area 54 is sized to circumscribe the larger of the length and height of sinusoidal score pattern 44. It is generally desirable to minimize the field area 54, because the size of the field area 54 determines the spot size of the laser beam 16. A smaller spot size of the laser beam 16 requires less power and is more efficient than the larger spot size for scoring most thin film materials.

As shown in FIG. 3B, the field area 54 may sometimes be smaller than the whole pattern. As shown, the score pattern 44 has a length greater than its height. To produce such a pattern 44 in the prior art, either the field area 54 had to be expanded to be equal to the greater of the length or the height, or the pattern had to be broken into multiple sub-patterns that fit within the field area 54. As previously mentioned, expanding the field area 54 results in an increased spot size and a loss of efficiency. To maintain a smaller field area 54, it was necessary to break the pattern 44 into multiple sub-patterns, and program the various sub-patterns into the control system during setup. This process substantially increased the setup time. Moreover, the prior art scoring process using sub-patterns experiences the same problems with mirror retraction as discussed with respect to FIG. 3A, namely laser beam spiking during retraction and misalignment 56 at each field transition.

In the present invention, as shown in FIG. 4A, the two-mirror system of the prior art can be replaced by a single moving mirror 30. By synchronizing the single galvo mirror 30 to the speed of the moving web 34, the repeating, contiguous pattern 44 can be scored or cut without turning off the laser beam 16 and without retracing the score line 44 for an entire roll of web material 34. Specifically, the galvo mirror 30 can be mounted perpendicular to the axis of the moving web 34. As the web 34 is advanced, the galvo motors 30 adjust the transverse angle α of the laser beam 16, such that the focal point of the beam 16 moves normal to the axis of the moving web 34. The transverse angle refers to the angle α of the beam 16 relative to the surface 40 of the web material 34 as viewed from the direction of the moving web 34. In this manner, the sinusoidal score line 44 can be cut by the laser beam 16 without retraction and without turning the beam 16 on and off. By producing the score line 44 without retraction and without turning the beam 16 on and off, issues of alignment and varying score depth are eliminated.

FIG. 4B illustrates a repeated score pattern that exceeds the field area 54 of the galvo laser. As previously indicated, generally the field area 54 of the galvo laser is defined according to the width and length of the score pattern. Specifically, the galvo field is in the shape of a square that circumscribes the entire score pattern 44. In this example, the pattern 44 is larger than the field area 54 of the galvo laser. To obtain the sharp angle, a dual moving mirror system is required. In the common and general method of scoring a continuous, repeated pattern that is larger than the field size 54 of the galvo system, the pattern 44 would have to be programmed as a series of smaller patterns requiring a retract with the beam off after each smaller pattern is processed. With the system 10 of the present invention, the entire repeat can be programmed without requiring the pattern 44 to be split into a series of smaller patterns and without the beam 16 having to be shut off. By synchronizing the galvo mirrors 30 to the moving web 34, the pattern 44 can be larger than the field size 54 of the galvo laser, without having to break the pattern 44 into smaller parts. The system 10 can position the beam 16 on the moving web 34 according to the speed of the web 34, without sacrificing accuracy.

As shown, the optical trigger 50 need only be printed on the web material at the beginning of each score pattern 44. By contrast, with the prior art system shown in FIG. 3B, an optical trigger 50 is required at the start point of each sub-pattern. Additionally, just before the beginning of each pattern and while awaiting the optical trigger 50, the laser beam 16 will be stationary at the same x-y location 54 as the start point. This ready-mode position allows the beam to remain on while awaiting the trigger 50 and guarantees a continuous, repeating score pattern without misalignment issues.

Therefore, the present invention is a system 10 and method for contour laser processing that utilizes either a single or dual moving mirror(s) 30 mounted to a single or dual axes for directing the laser beam 16 over a moving web 34. Using an encoder 38 to monitor the speed of the web 34 based on the rotation of a tension roller 48, the system 10 monitors and utilizes the web speed as a time reference. The encoder 38 transmits a clock signal representative of the speed of the moving web 34 to a computer 36, which controls both the laser power and the motion of the mirror 30 in a single axis system and both mirrors 30 in a dual axes system. The computer 36 uses the encoder signal as a clock signal to synchronize the time of the laser process to the web speed, so that as the web speed increases, the time required to laser process the web material 34 decreases proportionately. When the web 34 is stopped, no laser processing is performed.

| Cut | Angle | Dis- | Cut time (sec) | Spot Size | Energy Density |
|---|---|---|---|---|---|
| Length | θ | tance | (at 1000 ft/min | Diameter | (J/in * 100 |
| (in) | (Deg) | (in) | web speed) | (in) | Watts) |
| 6.1 | 30 | 7.0437 | 0.0176 | 0.0131059 | 0.25 |
| 6.1 | 35 | 7.4467 | 0.0214 | 0.0138558 | 0.25658371 |
| 6.1 | 40 | 7.9630 | 0.0256 | 0.014814 | 0.251468836 |
| 6.1 | 45 | 8.6267 | 0.0305 | 0.0160513 | 0.23570226 |
| 6.1 | 50 | 9.4899 | 0.0363 | 0.0176575 | 0.21007407 |
| 6.1 | 55 | 10.6350 | 0.0436 | | |
| 6.1 | 60 | 12.2000 | 0.0528 | | |
| 8.66 | 30 | 9.9997 | 0.0250 | 0.0131059 | 0.25 |
| 8.66 | 35 | 10.5719 | 0.0303 | 0.0138558 | 0.25658371 |
| 8.66 | 40 | 11.3048 | 0.0363 | 0.0148164 | 0.251458836 |
| 8.66 | 45 | 12.2471 | 0.0433 | 0.0160513 | 0.23570226 |
| 8.66 | 50 | 13.4726 | 0.0516 | 0.0176575 | 0.211007407 |
| 8.66 | 55 | 15.0982 | 0.0618 | | |
| 8.66 | 60 | 17.3200 | 0.0750 | | |
| 9.65 | 30 | 11.1429 | 0.0279 | 0.0131059 | 0.25 |
| 9.65 | 35 | 11.7805 | 0.0338 | 0.0138558 | 0.25658371 |
| 9.65 | 40 | 12.5972 | 0.0405 | 0.0148164 | 0.251468836 |
| 9.65 | 45 | 13.6472 | 0.0483 | 0.0160513 | 0.23570226 |
| 9.65 | 50 | 15.0127 | 0.0575 | 0.0176575 | 0.211007407 |
| 9.65 | 55 | 16.8243 | 0.0689 | | |
| 9.65 | 60 | 19.3000 | 0.0836 | | |

In a cross-web process application, a single moving mirror can be used where the moving mirror axis 30 is mounted at a support angle (θ) relative to the direction of motion of the moving web 34. As shown in the table, the support angle θ can be optimized for the cross-web line to be processed. The data in the table illustrates the energy density delivered at the cut point on the moving web in Joules per inch, assuming a relative web speed of approximately 1000 feet per minute. The table shows an optimum angle θ to power density ratio that is distributed along a power curve. As the angle θ increases from 30 degrees, the cut field diagonal length and the cut time both increase. However, the relative spot size becomes larger, thereby decreasing the efficiency of the beam, and consequently the power density first increases and then decreases in a bell curve. Typically, a low power beam 16 may be focused better than higher kilowatt lasers. Specifically, there is a lower defraction limit number (m²), a number which decreases the focus of a single high powered laser beam, such that a high power beam is typically less efficient.

The optimum energy density angle is approximately 35 degrees. The optimum angle θ depends in part on the spot size versus cutting power required, and therefore is somewhat dependent upon the speed of the web 34.

In a cross-web process application, if using a single moving mirror system, the mount axis will be mechanically set at a fixed angle θ relative to the moving web 34 and is preferably within the range of 30° to 60°. The smaller angle, such as 30°, leads to a smaller spot size and a more focused delivery of the beam 16 onto the moving web 34. Thus, less power is required to vaporize layers of the web material 34. However, the shorter axis angle θ also requires faster mirror movement in order to laser process a straight line (i.e. normal to the axis of moving web 34) onto the moving web 34. To maintain the same cut depth at a faster rate, more power is required. For the same type of cross-web process application, but using a dual moving mirror system, the axes will be set in a Cartesian coordinate (x,y) configuration, where the angle θ (with respect to the moving web) will be programmed as a combination of the web speed and the motion of the two moving mirrors 30.

As shown, the delivery of energy or the energy density of the beam 16 varies according to the angle of the axis arm relative to the speed of the moving web 34, such that independent of the cut length or the material to be cut, the energy density is optimized or optimal at approximately 35°. Thus, to maximize the efficiency of the laser cutting process whether a single or dual moving mirror system, the cut angle should be arranged or programmed at an angle of approximately 35° relative to a moving axis of the moving web for a straight line cut on a web moving at a rate of 1000 feet per minute. Other angles may optimize the delivery density of the beam at slower web speeds, for different types of cuts, or for different web materials. Generally, there will be an ideal axis angle θ for each laser process procedure. In the sine wave example of FIG. 4A, the ideal angle θ is 90 degrees, for a single moving mirror system.

In the prior art, the typical galvo laser system for laser processing of materials uses the rate of the web material and a time (determined by an internal clock) to determine the cut starting point and ending point (distance). In other words, the conventional galvo laser system operates in the time domain, processing the material along a pre-programmed, time-based motion profile. The laser cut will occur at the same rate regardless of web velocity or position. In the two-mirror system, as previously mentioned, the web position is added to the position of the in-line mirror 30, so that only the beam position of the in-line mirror 30 is tied to the motion of the web. In other words, the in-line mirror position is tied to the web by virtue of a web distance that is added to the position of the in-line mirror. Therefore, in the prior art, the laser process time is always the same regardless of the web speed, even if the web is stopped.

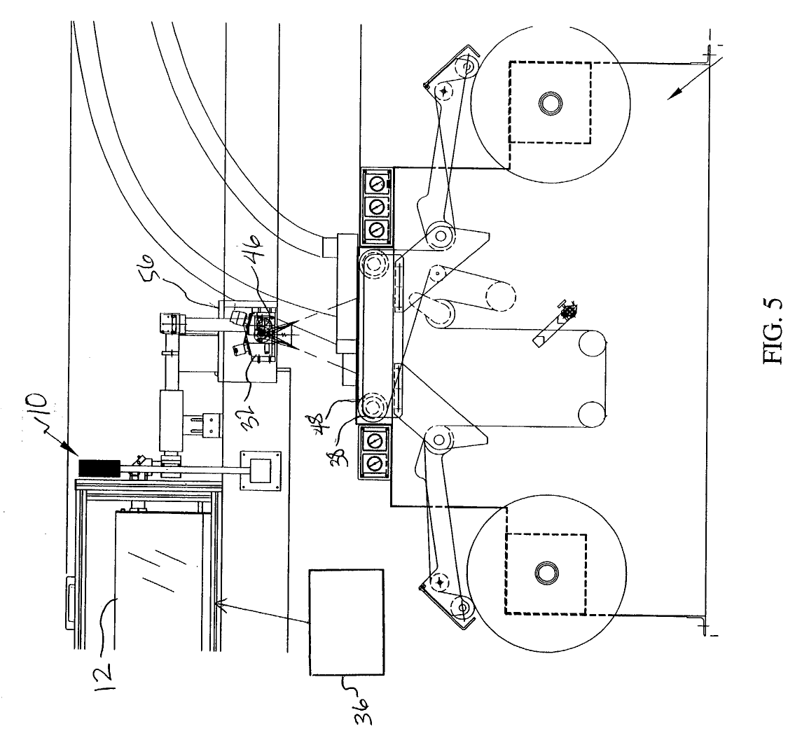

In the present invention, as shown in FIG. 5, an encoder 38 is attached to a tension roller 48 to measure the web speed. The scan head 32 is mounted on a support arm 56. In this case, the encoder 38 generates a clock signal, instead of a position signal. The encoder-generated clock signal is representative of the web speed, and the encoder 38 transmits the signal to the computer 36, which synchronizes the encoder clock signal with the laser power and the mirror 30 to precisely determine the start and end point of each cut. The cut is then performed on virtual time, based on the measured timing of the encoder 38. The encoder 38 generates a clock or timing signal, transmits the signal to the computer 36, which controls the galvo motors 46. Generally, the computer 36 can be a dedicated computer or a multi-purpose computers. In the preferred embodiment, the computer 36 is a standard computer workstations, such as a Windows PC, a Sun workstation, a Macintosh and the like. The encoder 38 synchronizes exactly the motion of the mirrors 30 with the speed of the moving web 34.

Using an encoder 38, if the web material 34 is advanced only a short distance, the encoder 38 signals the galvo motors 46, which adjust the mirrors 30 accordingly. The continuous encoder clock signal allows for incremental adjustment of the mirrors 30 in proportion to the amount of rotation measured by the encoder 38, using the web speed as a time reference (electronic camming). Thus, the mirrors 30 remain precisely synchronized to the moving web 34 regardless of changes in web speed.

By synchronizing the motor-control of the mirrors 30 with the speed of the moving web 34, faster speeds and better accuracy can be achieved. And unlike the prior art two-mirror systems, when the moving web 34 changes speeds or stops, the laser beam 16 and the moving mirrors 30 stop as well, because both are synchronized to the speed of the moving web 34. The encoder 38 generates a clock signal representative of the web's motion and transmits that clock signal to the computer 36. The computer 36 adjusts the mirror 30 and/or the laser power according to the encoder clock signal, so that the timing of the laser process adjusts the mirrors 30 accordingly, or stops the laser process altogether.

Various examples of different types of motion profiles used in laser processing are described below, illustrating where a single and dual moving mirror systems are appropriate, including the advantages and limitations of each. To perform a simple sinusoidal profile, only a single moving mirror 30 mounted to an axis perpendicular to the moving web 34 is required. A more complex profile that includes sharp angles on the moving web 34 cannot be performed with a single moving mirror, because straight corners would require infinite acceleration and deceleration of the moving mirrors 30. Corners would have radii, and the minimum radius is dependent on the response time of the mirror 30 and the speed of the web 34. To produce squared corners with the present system 10, a dual moving mirror system is required, with both mirrors 30 being synchronized to the moving web via the signal from the encoder 38.

As another example, to perform a cross-web laser process (a straight line across the web), again only a single moving mirror system is required. By orienting the support arm at an angle, for example 45° with respect to the web, it is possible to score a straight line across the moving web 34 using a single mirror. The method has the advantage of eliminating one of the axes. It has the additional advantage of lowering the cost by virtue of having fewer parts. However, to laser process a straight line, the moving mirror axis must maintain a constant scaled velocity relative to the web speed. The computer 36 again controls the moving mirror 30 according to the clock signal generated by the encoder 38, so as to maintain the proper relationship between laser process time and web speed. Generally, this is not a problem if the process allows for power levels of laser beam 12 to be constant during the laser process, or if the power levels can be varied and the laser 12 has sufficient power range.

Specifically, in a usage where first a cut-line and then a score line (or vice versa) is required along a thin film, either a slower speed in the beam's motion or a higher power level is required to accomplish the cut through. To produce the desired cut pattern 44, the laser must increase the power rapidly only at a single location before again reducing the power level and continuing on. If there is not sufficient power range in the laser, and a slower speed is required to supply more laser power to the process at the initial cut, the single mirror method will not cut a straight line. Such a pattern 44 requires a second synchronized mirror 30 to perform the initial cut. The position of the beam 16 may be maintained on the specific location along the moving web while the first mirror 30 moves to cut the rest of the score line.

As a last example, a single moving mirror system cannot cut closed-shaped profiles, such as circles, squares, and the like, since this requires multiple simultaneous cuts on a unidirectional web. However, these profiles can be accomplished with a dual moving mirror system.

The present invention presented herein may be implemented in numerous ways. The system 10 may be implemented using a single moving mirror wherein the mirror 30 and the laser power are controlled by a computer 36 using a clock signal generated by an encoder 38 attached to a tension roller 48. Thus, a clock signal representative of the speed of the moving web is used to synchronize the laser power and the motion of the mirrors to the speed of the moving web.

The system 10 may also be implemented using a dual moving mirrors, wherein two mirrors are moveably attached to each axis. In this case, both the motion of both mirrors 30 are synchronized to the speed of the moving web. In still another embodiment, multiple axes with multiple moveable mirrors 30 can be used. In each case, the motion of the mirrors 30 is synchronized precisely to the moving web 34.

In the preferred embodiment, the system 10 as described utilizes galvo technologies for the motion of the mirrors 30, but other techniques such as linear motors, voice-coil motors, high torque rotary motors, and the like could be used. Generally, the high torque rotary motors may be used for laser processes requiring higher accuracy, but lower frequency response than the galvo motors. The voice-coil motors can be used for laser processes requiring limited mirror motions.

The present invention has been described with respect to the laser processes, including cutting, scoring, perforating, slitting, marking, welding, sealing and the like. All such types of laser processes are equally relevant, and the effect is achieved in the same way, using different power levels and foci to effect the different types of laser processes.

In a system using a single moving mirror configuration where multiple single-mirror axes are required, the system described herein where the mirrors are synchronized to the motion of the moving web allows the axes to be arranged in closer physical proximity to each other than in a dual moving mirror configuration, due to the fact that a dual moving mirror system is larger than a single moving mirror system.

In addition, to lowering the cost by reducing the number of mirrors on each axis, the higher energy density allows for the use of lower powered lasers, which results in savings both in energy and in the cost of the mirror/motor/drive combinations. Mirror/motor/drive combinations can cost thousands of dollars, so cost savings achieved by reducing the number of mirrors may be significant over the whole system.

An additional advantage can also be achieved in the cost and complexity of the focusing lenses. Focusing can be achieved by using a variable focus lense wherein a motor drives one of the lenses back and forth to adjust the focus of the beam. Another method for focusing a beam involves the use of flat field lenses. In a two-mirror system, the two mirrors on an axis are at different distances from the focusing lense; therefore, the flat field lense must be designed so that the angle of incidence is different across the flat field lense to account for the spacing or distance between the two mirrors. Flat field lenses having varying angles of incidence across the lense to account for the distance between the two mirrors are very expensive. In a single moving mirror configuration, the flat field lense only focuses the beam for a single mirror, so the lense need not be designed to have varying angles of incidence across the lense surface. Thus, the flat field lense for the single moving mirror configuration is much less expensive.

The system 10 has been described with respect to a moving web 34. Generally, the phrase “moving web” refers to any material that can be continuously advanced under a laser beam. More specifically, the moving web 34 refers to any thin film material such as any printed or coated plastic or cellulose film, paper or Aluminum foil material. Additionally, the system 10 may be used to score any film, paper, foil, metallized material or laminate, such as those produced by adhesive, wax or extrusion lamination. Moreover, the system 10 may be used to score mono or co-extruded plastic films for special applications. Suitable materials include, but are not limited to, plastic or polymeric materials such as polyethylene (PE), linear and low-density polyethylene (LLDPE and LDPE), polyethyleneterephthalate (PET), oriented polypropylene (OPP), or other polymer. Similar polymers such as, for example, metallocene doped polyethylene are also within the scope of the present invention. Generally, the present invention may be used with either multi-layer homogenous or non-homogenous film materials or single-layer film materials of uniform composition. Generally, any type of flexible packaging material may be laser scored as taught by the present invention. For the purpose of this disclosure, the moving web 34 may be any flexible packaging material of either multiple layers of different compositions or a single layer of uniform composition.

Finally, though the invention has been described with respect to a moving web, the system 10 may also be applied to continuously moving discrete objects, sheets, or any other type of material on which laser processes are performed. Objects, such as bottles, candy wrappers, and the like, may be continuously advanced along a conveyor or by other means, so that the laser system 10 can be synchronized to the motion of the objects for precisely timing the laser process. Generally, the laser process is synchronized to the speed of the moving objects or workpieces, such that regardless of the substance or object type, the motion of the mirrors and the power of the beam are precisely synchronized to the movement of the substance or object type using electronic camming. Additionally, the electronic camming method allows the laser processes to be performed on moving objects wherein the speed of the object or web varies, without adversely effecting the precision of the laser processing. The laser process is synchronized to the motion, so that the laser process remains precisely synchronized even if the speed of the object changes over time.

Although the present invention has been described with reference to preferred embodiments, workers skilled in the art will recognize that changes may be made in form and detail without departing from the spirit and scope of the invention.

1. A system for laser processing, the system comprising:
a laser system having a beam source for generating a laser beam, at least one focusing lens for focusing the laser beam, and one or more adjustable mirror for directing the focused laser beam, each adjustable mirror having a motor for adjusting a mirror angle according to a predetermined pattern;
an encoder for monitoring a moving web and for generating an output signal; and
a control unit in communication with the power source and the motor for each adjustable mirror, the control unit for receiving the output signal and for synchronizing each adjustable mirror and the power source with the speed of the moving web based on the output signal.

2. The system of claim 1, wherein the output signal is a clock signal representative of a linear speed of the moving web.

3. The system of claim 1, wherein the moving web is a thin film material.

4. The system of claim 1, wherein the encoder is positioned on a roller of the laser system, and wherein the output signal is representative of rotational motion of the tension roller.

5. The system of claim 1, wherein the predetermined pattern is larger than a field size of the laser.

6. The system of claim 1, wherein the adjustable mirror directs a foci of the laser beam onto the moving web according to the mirror angle.

7. The system of claim 1, wherein the mirror angle changes according to a predetermined pattern.

8. The system of claim 1, wherein the motor is a galvo motor.

9. The system of claim 1 further comprising:
a computer memory in communication with the control unit, the computer memory for storing laser scoring patterns for implementation by the one or more adjustable mirrors.

10. A system for synchronizing motion of a laser beam to motion of a moving target, the system comprising:
a laser system having a beam source for generating a laser beam, at least one focusing lens for focusing the laser beam, and one or more moving mirror for directing the focused laser beam according to a stored pattern, each moving mirror having a motor for adjusting a mirror angle;
an encoder for measuring a speed of a moving target and for generating an output signal representative of the speed of the moving target; and
a control unit in communication with the laser system for providing a cut pattern, for receiving the output signal from the encoder, and for synchronizing the one or more moving mirrors to the speed of the moving target according to the output signal of the encoder.

11. The system of claim 10, wherein the speed is a rotational speed of a roller.

12. The system of claim 10, wherein the moving target is a workpiece disposed on a conveyor belt.

13. The system of claim 10, wherein the moving target is a thin film web material.

14. The system of claim 10, wherein the output signal is a clock signal representative of a linear speed of the moving target.

15. The system of claim 10, wherein the encoder is positioned on a roller of the laser system, and wherein the output signal is representative of rotational motion of the tension roller.

16. The system of claim 10, wherein the mirror angle changes according to a predetermined pattern.

17. The system of claim 10, wherein the speed of the moving target varies over time.

18. A method for synchronizing a laser beam with a moving target comprising:
generating with an encoder a signal representative of a measured speed of a moving target;
transmitting the signal to a pattern generator;
processing programmatically the transmitted signal with the pattern generator according to a predetermined pattern; and
generating output signals to one or more galvo motors for adjusting mirrors in real-time according to the processed signal.

19. The method of claim 18, further comprising;
generating signals to a beam source for modulating beam source power according to the processed signal.

20. The method of claim 18, further comprising:
directing a foci of the beam source onto a moving target; and
moving the foci of the beam source on the moving target according to the predetermined pattern.

21. A system for synchronizing motions of a laser beam to a speed of a moving web comprising:
a laser system having a beam source for generating a laser beam, at least one focusing lens for focusing the laser beam, and one or more moving mirror for directing the focused laser beam according to a laser process pattern, each moving mirror having a motor for adjusting a mirror angle;
an encoder for measuring a speed of a moving web and for generating an output signal representative of the speed of the moving web; and
a control unit in communication with the laser system for providing the laser process pattern, for receiving the output signal from the encoder, and for synchronizing the one or more moving mirrors to the speed of the moving target according to the output signal of the encoder.

22. The system of claim 21, wherein one mirror is mounted on a support arm oriented at an angle greater than zero degrees relative to a y-direction of the moving web.

23. The system of claim 22, wherein the one mirror adjusts in the x-direction, relative to the moving web, according to the laser process pattern and the speed of the moving web.

24. The system of claim 21, wherein the laser process pattern is greater than a field size of the laser system.

25. The system of claim 24, wherein the laser process pattern is stored in computer memory, wherein the laser process pattern is stored as a single pattern, and wherein the laser system draws the single pattern on the moving web without turning off the laser beam and without retracing the laser process pattern during retraction.
